(19) United States
(12) Patent Application Publication
(10) Pub. No.: US 2007/0299631 A1
(43) Pub. Date: Dec. 27, 2007

(54) LOGGING USER ACTIONS WITHIN ACTIVITY CONTEXT

(75) Inventors: Steven W. Macbeth, Snohomish, WA (US); Roland L. Fernandez, Woodinville, WA (US); Brian R. Meyers, Issaquah, WA (US); Desney S. Tan, Kirkland, WA (US); George G. Robertson, Seattle, WA (US); Nuria M. Oliver, Seattle, WA (US); Oscar E. Murillo, Seattle, WA (US); Elin R. Pedersen, Seattle, WA (US); Mary P. Czerwinski, Woodinville, WA (US); Jeanine E. Spence, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/426,846

(22) Filed: Jun. 27, 2006

(51) Int. Cl. G06F 19/00; G06F 17/40

(52) U.S. Cl. 702/187; 702/1; 702/127; 702/182; 702/189

(57) ABSTRACT

A system that can log user actions associated with an activity is disclosed. For example, the system can maintain a log of user keystrokes, files accessed, files opened, files created, websites visited, communication events (e.g., phone calls, instant messaging communications), etc. Additionally, the system can log extrinsic data (e.g., context data) associated with the user actions. As well, these logged actions can be aggregated, synchronized and/or shared between multiple users and/or devices.

This application is related to U.S. patent application Ser. No. ______ (Attorney Docket Number MS315860.01/MSFTP1291US) filed on Jun. 27, 2006, entitled “RESOURCE AVAILABILITY FOR USER ACTIVITIES ACROSS DEVICES”; ______ (Attorney Docket Number MS315861.01/MSFTP1292US) filed on Jun. 27, 2006, entitled “CAPTURE OF PROCESS KNOWLEDGE FOR USER ACTIVITIES”; ______ (Attorney Docket Number MS315862.01/MSFTP1293US) filed on Jun. 27, 2006, entitled “PROVIDING USER INFORMATION TO INTROSPECTION”; ______ (Attorney Docket Number MS315863.01/MSFTP1294US) filed on Jun. 27, 2006, entitled “MONITORING GROUP ACTIVITIES”; ______ (Attorney Docket Number MS315864.01/MSFTP1295US) filed on Jun. 27, 2006, entitled “MANAGING ACTIVITY-CENTRIC ENVIRONMENTS VIA USER PROFILES”; ______ (Attorney Docket Number MS315865.01/MSFTP1296US) filed on Jun. 27, 2006, entitled “CREATING AND MANAGING ACTIVITY-CENTRIC WORKFLOW”; ______ (Attorney Docket Number MS315866.01/MSFTP1297US) filed on Jun. 27, 2006, entitled “ACTIVITY-CENTRIC ADAPTIVE USER INTERFACE”; ______ (Attorney Docket Number MS315867.01/MSFTP1298US) filed on Jun. 27, 2006, entitled “ACTIVITY-CENTRIC DOMAIN SCOPING”; and ______ (Attorney Docket Number MS315868.01/MSFTP1299US) filed on Jun. 27, 2006, entitled “ACTIVITY-CENTRIC GRANULAR APPLICATION FUNCTIONALITY”. The entirety of each of the above applications is incorporated herein by reference.

### BACKGROUND

Human-human communication typically involves spoken language combined with hand and facial gestures or expressions, and with the humans understanding the context of the communication. Human-machine communication is typically much more constrained, with devices like keyboards and mice for input, and symbolic or iconic images on a display for output, and with the machine understanding very little of the context. For example, although communication mechanisms (e.g., speech recognition systems) continue to develop, these systems do not automatically adapt to the activity of a user. As well, traditional systems do not consider contextual factors (e.g., user state, application state, environment conditions) to improve communications and interactivity between humans and machines.

Activity-centric concepts are generally directed toward ways to make interaction with computers more natural (by providing some additional context for the communication). Traditionally, computer interaction centers around one of three pivots, 1) document-centric, 2) application-centric, and 3) device-centric. However, most conventional systems cannot operate upon more than one pivot simultaneously, and those that can do not provide much assistance managing the pivots. Hence, users are burdened with the tedious task of managing even minor aspects of their tasks/activities.

A document-centric system refers to a system where a user first locates and opens a desired data file before being able to work with it. Similarly, conventional application-centric systems refer to first locating a desired application, then potentially opening and/or creating a file or document using the desired application or perhaps connecting to another form of data. Finally, a device-centric system refers to first choosing a device for a specific activity and then potentially finding the desired application and/or document and subsequently working with the application and/or document with the chosen device.

Accordingly, since the traditional computer currently has little or no notion of activity built in to it, users are provided little direct support for translating the “real world” activity they are trying to use the computer to accomplish and the steps, resources and applications necessary on the computer to accomplish the “real world” activity. Thus, users traditionally have to assemble “activities” manually using the existing pieces (e.g., across documents, applications, and devices). As well, once users manually assemble these pieces into activities, they need to manage this list mentally, as there is little or no support for managing this on current systems.

All in all, the activity-centric concept is based upon the notion that users are leveraging a computer to complete some real world activity. Historically, a user has had to outline and prioritize the steps or actions necessary to complete a particular activity mentally before starting to work on that activity on the computer. Conventional systems do not provide for systems that enable the identification and decomposition of actions necessary to complete an activity. In other words, there is currently no integrated mechanism available that can dynamically understand what activity is taking place as well as what steps or actions are necessary to complete the activity.

Most often, the conventional computer system has used the desktop metaphor, where there was only one desktop. Moreover, these systems normally stored documents using the metaphor of a filing cabinet where each item can be found at only one location. As the complexity of activities rises, and as the similarity of the activities diverges, this structure does not offer user-friendly access to necessary resources for a particular activity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can log user actions, for example, the system can maintain a log of user keystrokes, mouse clicks, files accessed, files opened, files created, websites visited, applications run, communication events (e.g., phone calls, instant messaging communications), etc. These user actions can be stored in connection with a particular activity. Moreover, user actions can be logged in connection with a user context. As well, these logged actions can be aggregated, synchronized and/or shared between multiple devices or people.

The system can facilitate associating the logged actions with one or more specific activities. Association of actions to activities can be accomplished manually or automatically, e.g., based upon heuristically searching files. In one aspect, a user can explicitly identify the activity. In another aspect, the system can infer the activity based upon activity information gathered. In yet another aspect, the system can employ extrinsic data to determine and/or infer an action. The extrinsic factors can include but, are not limited to, temporal context, personal data (e.g., PIM data), environment context, user context, device profile, etc. Other aspects can analyze content of a file in order to determine actions associated with an activity.

The logged information can be employed to facilitate an action. For example, the innovation can track changes to a website in real time. This information can be employed to determine and render information such as what documents have been updated and who is doing the work, etc. By way of further specific example, with respect to an activity scenario such as creating a group status report, the information gathered can facilitate determining what items to publish and what still needs to be completed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates logging user actions in accordance with an aspect of the innovation.

FIG. 2 illustrates an exemplary flow chart of procedures that facilitate logging actions associated to an activity in accordance with an aspect of the innovation.

FIG. 3 illustrates an exemplary flow chart of procedures that facilitate determining an activity and logging actions in accordance with an aspect of the innovation.

FIG. 4 illustrates an overall activity-centric system in accordance with an aspect of the innovation.

FIG. 5 illustrates a block diagram of a system that employs a monitoring component in accordance with an aspect of the innovation.

FIG. 6 illustrates an exemplary monitoring component in accordance with an aspect of the innovation.

FIG. 7 illustrates a system that employs an extrinsic data collaboration component and an activity inference component in accordance with an aspect of the innovation.

FIG. 8 illustrates a system having a log management component with a logging policy and action record component in accordance with an aspect of the innovation.

FIG. 9 illustrates an exemplary architecture of a system that employs a generic, third party and first party logging policy in accordance with an aspect of the innovation.

FIG. 10 illustrates a system that employs a granularity component in accordance with an aspect of the innovation.

FIG. 11 illustrates a block diagram of a computer operable to execute the disclosed architecture.

FIG. 12 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

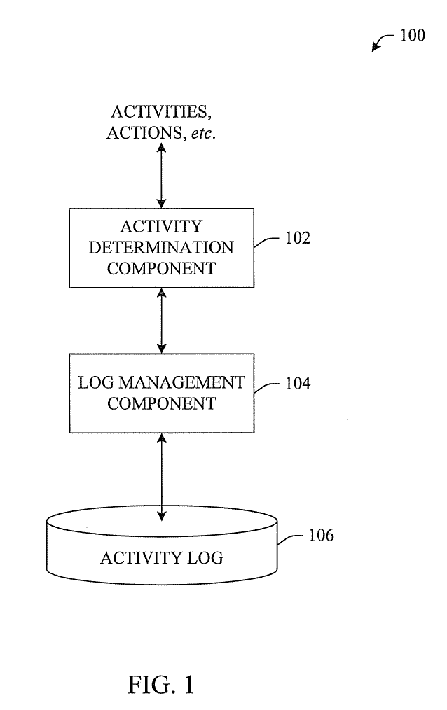

Referring initially to the drawings, FIG. 1 illustrates a system 100 that facilitates logging actions associated with an activity in accordance with an aspect of the innovation. Generally, system 100 can include an activity determination component 102, a log management component 104 and an activity log 106. Although the components (102, 104, 106) are illustrated in series in FIG. 1, it is to be understood that each of the components (102, 104, 106) can be located remotely from the others without departing from the spirit and/or scope of the innovation and claims appended hereto.

In operation, user actions (e.g., keystrokes, mouse movements, spoken words, gestures, eye movements, places visited, files accessed, applications launched, etc.) can be observed by the activity determination component 102. The activity determination component 102 can facilitate identifying an activity associated with all, or a subset, of the user actions. In another aspect, the activity determination component 102 can infer an associated activity based upon statistical and/or historical data as a function of the user action data.

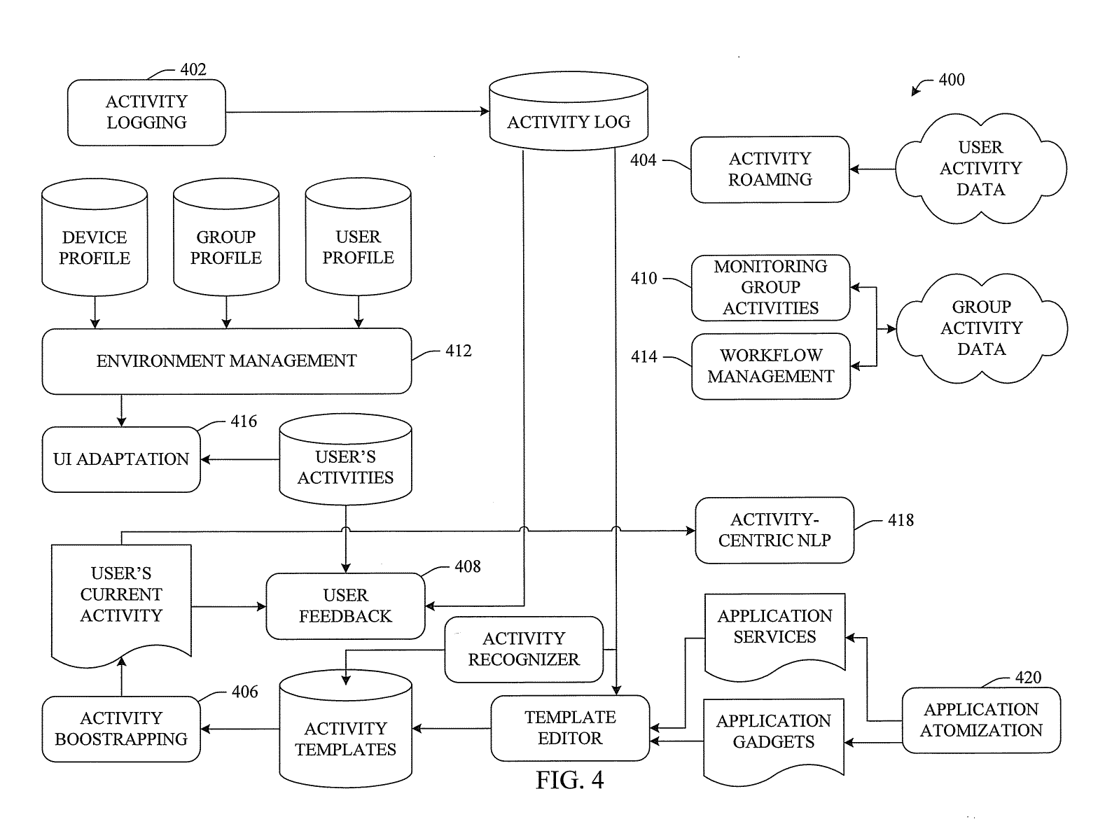

The log management component 104 can record all, or a subset of the actions into an activity log 106. Additionally, the actions can be associated (e.g., linked, tagged) to an associated activity or group of associated activities. The associated actions can be employed by an activity-centric system to prompt action in a variety of manners. As will be understood upon a review of the overall activity-centric system of FIG. 4, the system can employ the associated actions to manage workflow, transfer activity and log information between devices, scope and/or atomize application functionality, dynamically adjust user interface (UT) characteristics, etc.

For example, the system 100 can employ logging to facilitate a predictive UI. In a scenario where a user is leaving their office to attend a meeting, the system can employ logged activity data to automatically determine members of an activity and to send an email to the meeting participants including a pointer to the documents that the user has been creating for the meeting and mentioning that the user will be running late. Effectively, the logged actions can be used to prompt substantially any activity-centric action associated with a particular activity.

In general, in one aspect, logging activity actions refers to recording interactions between the user and a computer as well as extrinsic data (e.g., context data) related thereto. As described above, this logging function can be facilitated via the log management component 104. As well, the activity determination component 102 can be used to determine and/or infer an activity based upon the actions logged. In other aspects, a user can identify the activity for which to associate an action or group of actions.

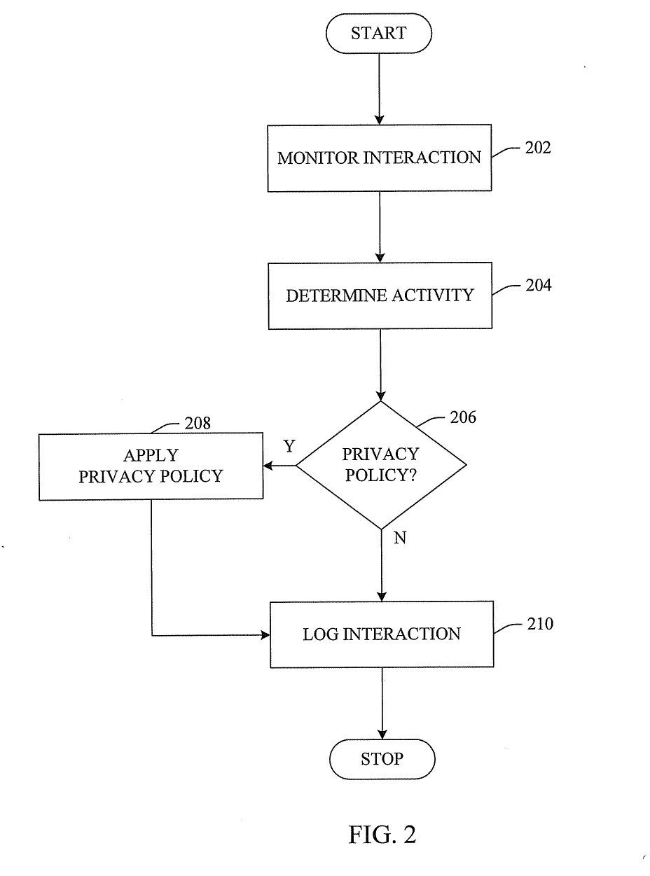

FIG. 2 illustrates a methodology of logging an action in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, interaction between a user and a computer can be monitored. As described above, the system can monitor keyboard input, mouse movements, files accessed, words spoken, gestures, eye movements, etc. In aspects, sensors can be employed to capture the actions and information. For instance, the sensors can include, keystroke tracking mechanisms, image capture devices, microphones, etc. As well, other context sensors can be employed to capture activity context, user context and environment context factors, all of which can be logged via the log management component 104 into activity log 106.

The activity can be determined or inferred from the monitored information at 204. As well, in other aspects, the activity can be explicitly identified by a user. In either case, the activity can be associated with the monitored information from 202.

Next, at 206, a determination can be made if a privacy policy is to be employed in connection with particular logged actions and/or identified activity. If so, the privacy policy can be applied at 208. For instance, if a user is working with confidential information or visiting and/or conferring with privileged high profile persons, a privacy policy may be appropriate. Similarly, a user's role can be employed to determine if a privacy policy should be used to mask, filter and/or screen information at 208. Another exemplary possibility is that the interaction and activity data can be logged, but the entry in the log is tagged as being only accessible to user's with appropriate access rights. That is, the privacy policy may cause an entry to be filtered (not logged), logged with restricted access, or logged for general access.

In either instance, the interactions can be logged at 210. As shown in FIG. 1, the interactions, activity data and other extrinsic data can be logged in an activity log. The activity log can be most any storage device (e.g., data store, magnetic disc, CD, cache, memory, etc.). As well, the activity data can be logged locally and/or remotely (as well as in multiple locations).

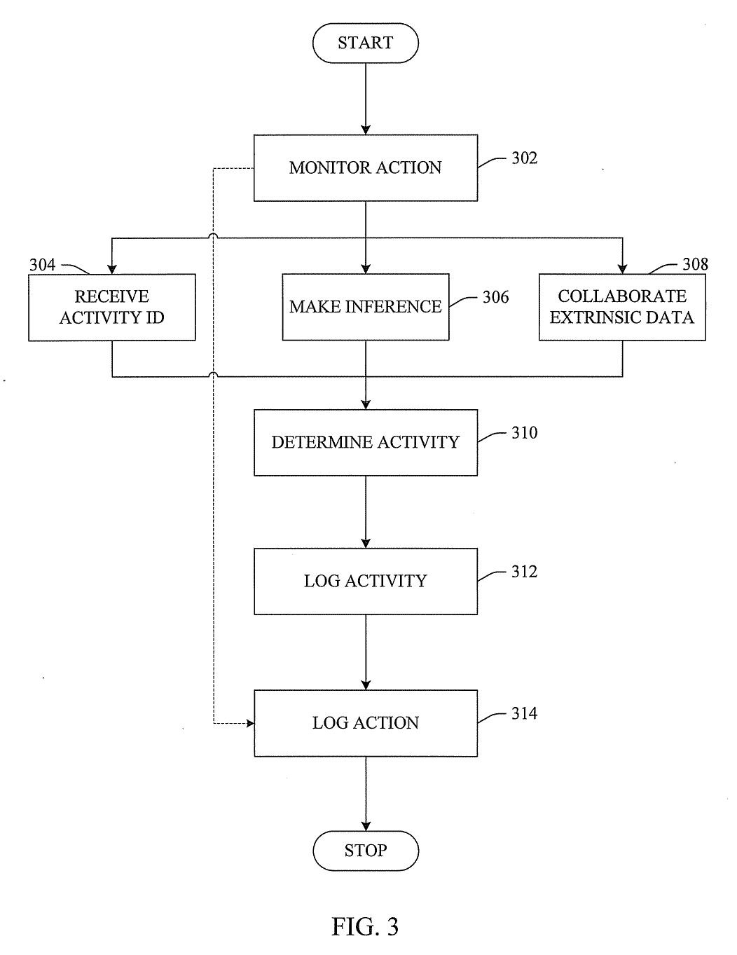

FIG. 3 illustrates yet another methodology of logging user actions in accordance with an aspect of the innovation. Beginning at 302, a user action can be monitored. For example, as described supra, the action can be a keyboard input, audible command, data accessed, places visited, etc. At, 304, 306 and 308, information regarding an activity can be obtained.

Referring first to 304, a user can explicitly identify an activity associated to an action or set of actions. As shown, an activity identification (ID) can be received from a user, application and/or activity management system. This ID can be used as a tag to associate the activity to an action or set of actions.

In another aspect, an inference can be made at 306 to identify an activity based upon an action or set of actions. As will be described infra, artificial intelligence (AI) or other machine learning and/or reasoning (MLR) mechanism can be employed to infer an associated activity. Once inferred, this activity identification can be used to link detected actions to an activity (or group of activities) in a log.

Still further, at 308, extrinsic data (e.g., environment data) can be employed to assist in determining an activity. For example, location, time/date, etc. can be employed to assist in an activity determination at 310. The activity and action(s) information can be logged at 312 and 314 respectively. As described herein, metadata, tags, etc. can be used to associate the action(s) to an activity or group of activities. As described in FIG. 4 that follows, these logged actions and activity data can be used to effectuate activity-centric actions such as workflow management, application/activity scoping, UI adaptation, functionality atomization, etc.

Alternative, and frequently, it is to be understood that other aspects can monitor action at 302 and directly log action at 314. These aspects of the process flow are illustrated by the dashed arrow in the flow diagram of FIG. 3. It is further to be understood that other aspects can include a combination of the flow paths illustrated in FIG. 3. These alternative aspects are to be included within the scope of the disclosure and claims appended hereto.

Turning now to FIG. 4, an overall activity-centric system 400 operable to perform novel functionality described herein is shown. As well, it is to be understood that the activity-centric system of FIG. 4 is illustrative of an exemplary system capable of performing the novel functionality of the Related Applications identified supra and incorporated by reference herein. Novel aspects of each of the components of system 400 are described below.

The novel activity-centric system 400 can enable users to define and organize their work, operations and/or actions into units called “activities.” Accordingly, the system 400 offers a user experience centered on those activities, rather than pivoted based upon the applications and files of traditional systems. The activity-centric system 400 can also usually include a logging capability, which logs the user's actions for later use.

In accordance with the innovation, an activity typically includes or links to all the resources needed to perform the activity, including tasks, files, applications, web pages, people, email, and appointments. Some of the benefits of the activity-centric system 400 include easier navigation and management of resources within an activity, easier switching between activities, procedure knowledge capture and reuse, improved management of activities and people, and improved coordination among team members and between teams.

As described herein and illustrated in FIG. 4, the system 400 discloses an extended activity-centric system. The particular innovation (e.g., logging activity information) disclosed herein is part of the larger, extended activity-centric system 400. An overview of this extended system 400 follows.

The “activity logging” component 402 can log the user's actions on a device to a local (or remote) data store. By way of example, these actions can include, but are not limited to include, keyboard input, audible commands, gestures, eye movement, resources opened, files changed, application actions, etc. As well, the activity logging component 402 can also log current activity and other related information (e.g., context data). This data can be transferred to a server that holds the user's aggregated log information from all devices used. The logged data can later be used by the activity system in a variety of ways.

user's activities, including related resources and the “state” of open applications, on a server and making them available to the device(s) that the user is currently using. As well, the resources can be made available for use on devices that the user will use in the future or has used in the past. The activity roaming component 404 can accept activity data updates from devices and synchronize and/or collaborate them with the server data.

The “activity boot-strapping” component 406 can define the schema of an activity. In other words, the activity boot-strapping component 406 can define the types of items it can contain. As well, the component 406 can define how activity templates can be manually designed and authored. Further, the component 406 can support the automatic generation, and tuning of templates and allow users to start new activities using templates. Moreover, the component 406 is also responsible for template subscriptions, where changes to a template are replicated among all activities using that template.

The “user feedback” component 408 can use information from the activity log to provide the user with feedback on his activity progress. The feedback can be based upon comparing the user's current progress to a variety of sources, including previous performances of this or similar activities (using past activity log data) as well as to “standard” performance data published within related activity templates.

The “monitoring group activities” component 410 can use the log data and user profiles from one or more groups of users for a variety of benefits, including, but not limited to, finding experts in specific knowledge areas or activities, finding users that are having problems completing their activities, identifying activity dependencies and associated problems, and enhanced coordination of work among users through increased peer activity awareness.

The “environment management” component 412 can be responsible for knowing where the user is, the devices that are physically close to the user (and their capabilities), and helping the user select the devices used for the current activity. The component 412 is also responsible for knowing which remote devices might be appropriate to use with the current activity (e.g., for processing needs or printing).

The “workflow management” component 414 can be responsible for management and transfer of work items that involve other users or asynchronous services. The assignment/transfer of work items can be ad-hoc, for example, when a user decides to mail a document to another user for review. Alternatively, the assignment/transfer of work items can be structured, for example, where the transfer of work is governed by a set of pre-authored rules. In addition, the workflow manager 414 can maintain an “activity state” for workflow-capable activities. This state can describe the status of each item in the activity, for example, which it is assigned to, where the latest version of the item is, etc.

The “UI adaptation” component 416 can support changing the “shape” of the user's desktop and applications according to the current activity, the available devices, and the user's skills, knowledge, preferences, policies, and various other factors. The contents and appearance of the user's desktop, for example, the applications, resources, windows, and gadgets that are shown, can be controlled by associated information within the current activity. Additionally, applications can query the current activity, the current “step” within the activity, and other user and environment factors, to change their shape and expose or hide specific controls, editors, menus, and other interface elements that comprise the application's user experience.

The “activity-centric recognition” component or “activity-centric natural language processing (NLP) component 418 can expose information about the current activity, as well as user profile and environment information in order to supply context in a standardized format that can help improve the recognition performance of various technologies, including speech recognition, natural language recognition, optical character recognition, gesture recognition, desktop search, and web search.

Finally, the “application atomization” component 420 represents tools and runtime to support the designing of new applications that consist of services and gadgets. This enables more fine-grained UI adaptation, in terms of template-defined desktops, and well as adapting applications. The services and gadgets designed by these tools can include optional rich behaviors, which allow them to be accessed by users on thin clients, but deliver richer experiences for users on devices with additional capabilities.

In accordance with the activity-centric environment 400, once the computer understands the activity, it can adapt to that activity. For example, if the activity is the review of a multi-media presentation, the application can display the information differently as opposed to an activity of the UI employed in creating a multi-media presentation. All in all, the computer can react and tailor functionality and the UI characteristics based upon a current state and/or activity. The system 400 can understand how to bundle up the work based upon a particular activity. Additionally, the system 400 can monitor actions and automatically bundle them up into an appropriate activity or group of activities. The computer will also be able to associate a particular user to a particular activity, thereby further personalizing the user experience.

In summary, the activity-centric concept of the subject system 400 is based upon the notion that users can leverage a computer to complete some real world activity. As described supra, historically, a user would outline and prioritize the steps or actions necessary to complete a particular activity mentally before starting to work on that activity on the computer. In other words, conventional systems do not provide for systems that enable the identification and decomposition of actions necessary to complete an activity.

The novel activity-centric systems enable automating knowledge capture and leveraging the knowledge with respect to previously completed activities. In other words, in one aspect, once an activity is completed, the subject innovation can infer and remember what steps were necessary when completing the activity. Thus, when a similar or related activity is commenced, the activity-centric system can leverage this knowledge by automating some or all of the steps necessary to complete the activity. Similarly, the system could identify the individuals related to an activity, steps necessary to complete an activity, documents necessary to complete, etc. Thus, a context can be established that can help to complete the activity next time it is necessary to complete. As well, the knowledge of the activity that has been captured can be shared with other users that require that knowledge to complete the same or a similar activity.

Historically, the computer has used the desktop metaphor, where there was effectively only one desktop. Moreover, conventional systems stored documents using a filing cabinet metaphor where each item had only one location. As the complexity of activities rises, and as the similarity of the activities diverges, it can be useful to have many desktops available that can utilize identification of these similarities in order to streamline activities. Each individual desktop can be designed to achieve a particular activity. It is a novel feature of the innovation to build this activity-centric infrastructure into the operating system such that every activity developer and user can benefit from the overall infrastructure.

The activity-centric system proposed herein is made up of a number of components as illustrated in FIG. 4. It is the combination and interaction of these components that compromises an activity-centric computing environment and facilitates the specific novel functionality described herein. In one aspect and at the lowest level, the following components make up the core infrastructure that is needed to support the activity-centric computing environment; Logging application/user actions within the context of activities, User profiles and activity-centric environments, Activity-centric adaptive user interfaces, Resource availability for user activities across multiple devices and Granular applications/web-services functionality factoring around user activities. Leveraging these core capabilities with a number of higher-level functions are possible, including; providing user information to introspection, creating and managing workflow around user activities, capturing ad-hoc and authored process and technique knowledge for user activities, improving natural language and speech processing by activity scoping, and monitoring group activity.

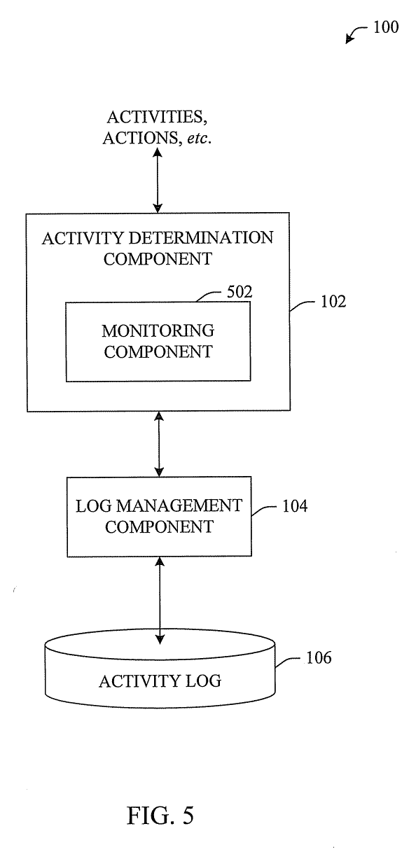

Referring now to FIG. 5, an alternative block diagram of system 100 in accordance with an aspect of the innovation is shown. More particularly, in accordance with the system 100, activity determination component 102 can include a monitoring component 502 that can monitor activity-related actions. Although the monitoring component 502 is illustrated inclusive of activity determination component 102, it is to be understood and appreciated that the monitoring component 502 can be external or remote from the activity determination component 102 without departing from the spirit and scope of the innovation.

In operation, in addition to monitoring user interactions, the monitoring component 502 can be employed to establish activity context information, user context information, environment context information or the like. With respect to the activity context information, the monitoring component 502 can be used to identify information such as the current activity, current step within the activity and current resource accessed with respect to the activity. The user context information can include data such as a user's knowledge of an activity topic, state of mind and data last accessed by the user. Moreover, the environment context can include physical conditions, social settings, people present, security ratings, date/time, location, etc. All of this data can be used to determine an activity (e.g., via activity determination component 102). As well, this data can be logged (e.g., via log management component 104) and used in connection with activity-centric sub-processes as identified in FIG. 4.

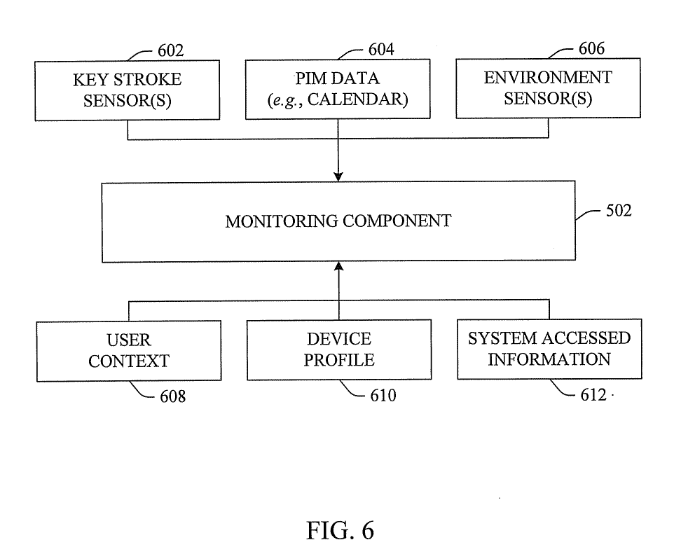

FIG. 6 illustrates a block diagram of a monitoring component 502 in accordance with an aspect of the innovation. As shown, monitoring component 502 can employ keystroke sensors 602 to record user keyboard input. Personal information manager (PIM) data 604 can be monitored and used to assist in determining an associated activity. For example, a user's calendar can be used to help in identifying a user schedule thus, to increase the likelihood and accuracy of correctly identifying an activity associated to monitored actions.

Environment sensors 606 can be employed to identify other extrinsic data that can assist in activity determination. For example, in one aspect, image capture devices can be employed together with pattern recognition systems and/or facial recognition systems to identify individuals within close proximity of a user. Similarly, global positioning systems (GPS) can be used to determine a user location. This information, together with other context data, can be used to identify an activity and/or associate actions to an activity.

Moreover, user context data 608, device profile data 610 and/or system accessed information 612 can be used to assist in identifying an activity. As well, this information can be logged and used by the system to effectuate activity-centric actions and procedures described with reference to FIG. 4.

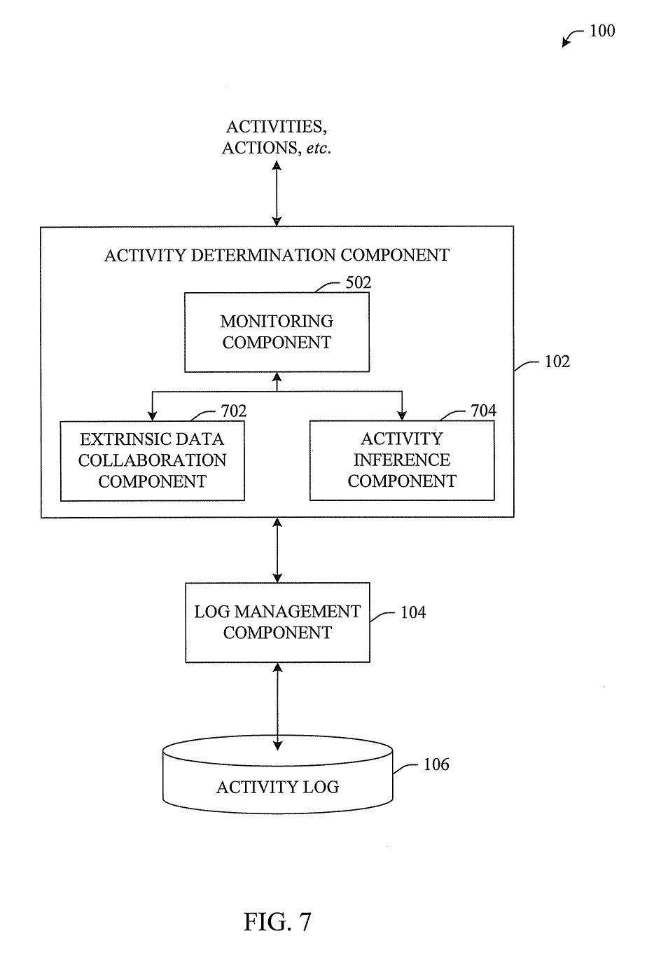

FIG. 7 illustrates yet another alternative block diagram of system 100 in accordance with an aspect of the innovation. As shown in FIG. 7, in addition to the monitoring component 502, activity determination component 102 can include an extrinsic data collaboration component 702 and an activity inference component 704.

As described supra, the monitoring component 502 can automatically and/or dynamically record all interactions (e.g., keyboard input, mouse movements, audible inputs, visual inputs, gestures, verbal) between a user and a computer. Further, the system can record extrinsic data from sensors either on a user or with respect to the environment around the user. In one specific scenario, sensors can be employed to record the number of people that are in an office at any one time. Further, the system can identify the persons, their roles within an activity or organization, etc.—all of which can be used in an activity-centric system to assist in activities. The extrinsic data collaboration component 702 can be used to aggregate and/or cluster this extrinsic information.

In operation, in one aspect, the activity inference component 704 can employ the extrinsic data to infer an activity. Accordingly, the system can associate user action information with the inferred activity upon logging the data within the data log 106. It is to be understood that, in addition to user action data, the system can also log extrinsic data such as activity context, user context, environment context, or the like associated to a particular activity and/or group of activities. All of this captured information can be employed to assist the inference component 704 in determining an activity.

In one aspect, the system 100 can include an MLR component that facilitates inferring the activity from information such as user actions and interactions, context data, etc. The MLR component facilitates automating one or more features in accordance with the subject innovation.

More particularly, the subject innovation (e.g., in connection with activity determination, policy application, etc.) can employ various Al-based schemes for carrying out various aspects thereof. For example, a process for determining when/if an action should be logged can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic, statistical and/or decision theoretic-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. By defining and applying a kernel function to the input data, the SVM can learn a non-linear hypersurface. Other directed and undirected model classification approaches include, e.g., decision trees, neural networks, fuzzy logic models, naïve Bayes, Bayesian networks and other probabilistic classification models providing different patterns of independence can be employed.

As will be readily appreciated from the subject specification, the innovation can employ classifiers that are explicitly trained (e.g., via a generic training data) as well as implicitly trained (e.g., via observing user behavior, receiving extrinsic information). For example, the parameters on an SVM are estimated via a learning or training phase. Thus, the classifier(s) can be used to automatically learn and perform a number of functions, including but not limited to determining according to a predetermined criteria the nature of an activity, when/if an action/interaction/contextual factor should be logged, etc.

Ultimately, one novel feature of the innovation discloses mechanisms to infer, synthesize and employ the information gathered and logged with regard to interaction and context. For example, the information can be used to complete time-sheets or status reports or to assist a user in understanding how an activity relates to user-defined priorities, for example, time management, workflow management, etc. Further, this logged information can be employed to effectuate other novel activity-centric processes as described with reference to FIG. 4 as well as with reference to the Related Applications defined above and incorporated by reference herein.

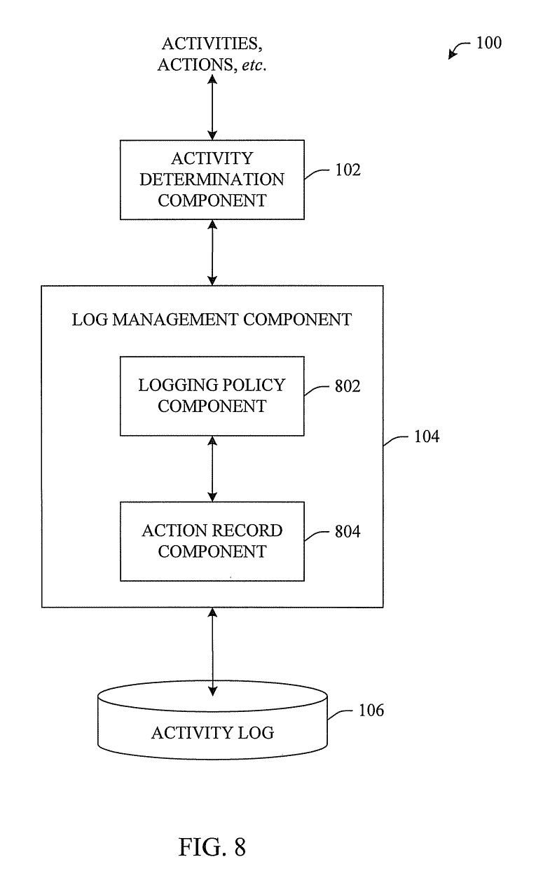

Turning now to FIG. 8, an alternative diagram of a system 100 that can facilitate logging information (e.g., actions, context, extrinsic data, etc.) with respect to an activity is shown. As shown in FIG. 8, the log management component 104 can include a logging policy component 802 and/or an action record component 804. Each of the these components (802, 804) can be employed to determine if an action (or other context information) should be recorded.

As described above, with respect to activity-centric systems, the system 100, via the log management component 104, can register both low level and high level information. In summary, the subject system 100 discloses novel mechanisms by which most any interactive and contextual information can be recorded with respect to an activity. In operation, the system 100 can monitor and record the interactions and context information thereafter clustering the information into groups related to a particular activity. This information can then be used with respect to activity-centric operation such as task management of an activity. Thus, because the system can dynamically and/or automatically group information, the user would not have to explicitly group information together, although explicit grouping is also possible in accordance with aspects of the innovation.

The logging policy component 802 can be employed to impose and/or enforce rules and policies upon the tracking of information. In one example, the logging policy component 802 can be related to the confidentiality and/or sensitivity of the information. In this example, the logging policy component 802 can consider a sensitivity factor related to information together with an activity role of a user in order to determine if information should be recorded by the action record component 804.

Effectively, there are at least three ways that the action record component 804 can relate a group of actions to an activity. First, the user can explicitly identify a particular activity, thus, the system 100 can automatically record interactions, files worked on, websites visited, etc. with respect to the pre-identified activity.

In a second scenario, as described supra, the activity determination component 102 can infer an associated activity based upon MLR mechanisms. More particularly, with respect to clustering, the system can analyze lower level events (e.g., user action) and cluster these entries into a higher level set of events. As such, algorithmic techniques can be employed to identify patterns and to infer actions based upon the logged data.

In yet a third scenario, the system 100 can integrate the low level logging together with extrinsic information. By way of example, the system can access extrinsic information maintained within a calendar (e.g., PIM data) to assist with identification of an activity. Each of these scenarios can be controlled via the log management component 802.

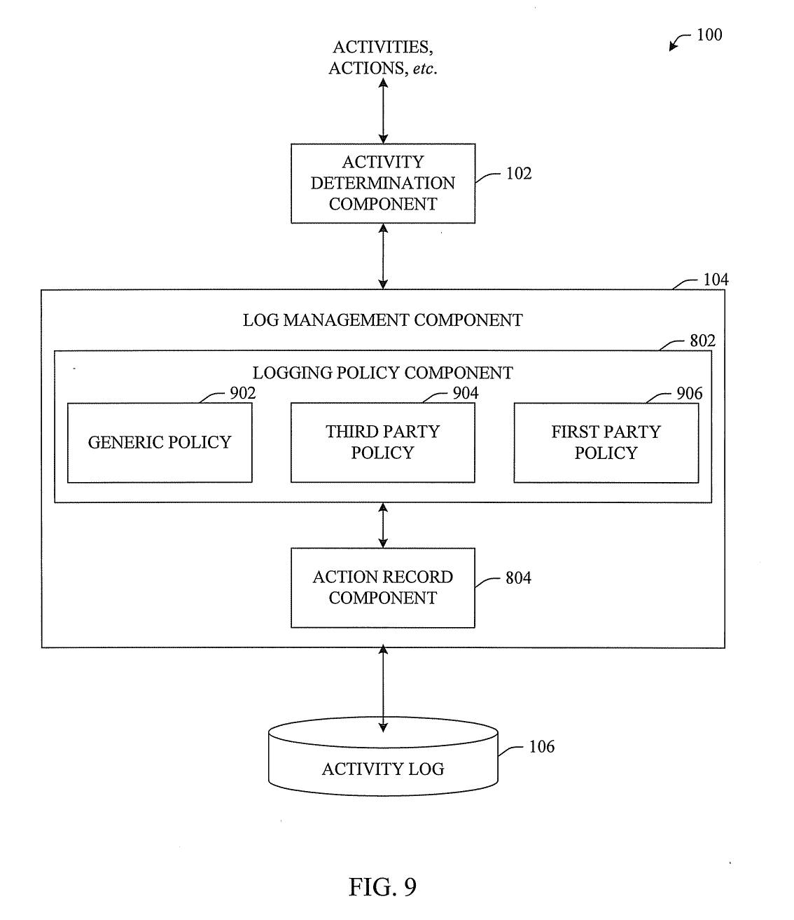

As shown in FIG. 9, in one aspect, the log management component 802 can include a generic policy 902, a third party policy 904 and/or a first party policy 906. Effectively, the log management component 802 can include policies that applied to all information (e.g., generic policy 902), policies that are developed by a third party different from an application developer (e.g., 904), as well as a first party policy (e.g., 906), for example, an application developer's policy.

In accordance with an appropriate policy, the system 100 can log all low level interactions (e.g., key strokes, mouse movements, etc.) and evaluate the interactions with respect to extrinsic information such as an event that appears on a user's calendar. By way of further example, the system can employ extrinsic information from a user's calendar, for example, identification of a “busy” block in time with respect to an event. As such, by combining the calendar with the logged information and room sensor information (e.g., identification of people), the system can obtain more accurate descriptions of the activity thereby, improving clustering ability and activity determination.

In another example, if a meeting is on the calendar and room sensors determine that the user is not present in his office, it can be inferred at a high probability that the user is attending the meeting. In a third example, if a meeting is on the calendar and room sensors determine that several people are present in the office, and the log indicates that the keyboard and mouse are active, it can be inferred with high probability that the user is demonstrating something to people in that meeting, or they are jointly engaged in some activity on the computer.

In summary, there are at least three ways that the activity determination component 102, together with the logging policy component 802, can be employed to determine an activity: 1—explicit knowledge from a user, 2—analyzing low level interactions, and 3—combining information sources (e.g., low level interactions with extrinsic data). Additionally, it is to be understood that the information logged can be conveyed to a user in order to give the user the ability to verify and/or modify the information. As well, in accordance with this user rendering capability, the system 100 can enable a user to identify why a particular entry was incorrect thereby enabling the system 100 to learn and perform a more accurate job in the future of recording and inferring actions.

As described above, in addition to the core functionality of logging actions and context data, the innovation can provide for an application program interface (API) that enables applications to determine if they should or should not log interactions. With continued reference to FIG. 9, there can be a three level architecture driver model or logging policy component 802. This component 802 can have a first level which is basically a generic driver (902) that can log everything without knowing anything about an application. A second level can be a third party application driver (904) that is not written by the application developer but rather a third party. Thus, the third party can control what is logged. Finally, there can be a first party application driver (904) where the application developer decides what will be logged with respect to an application.

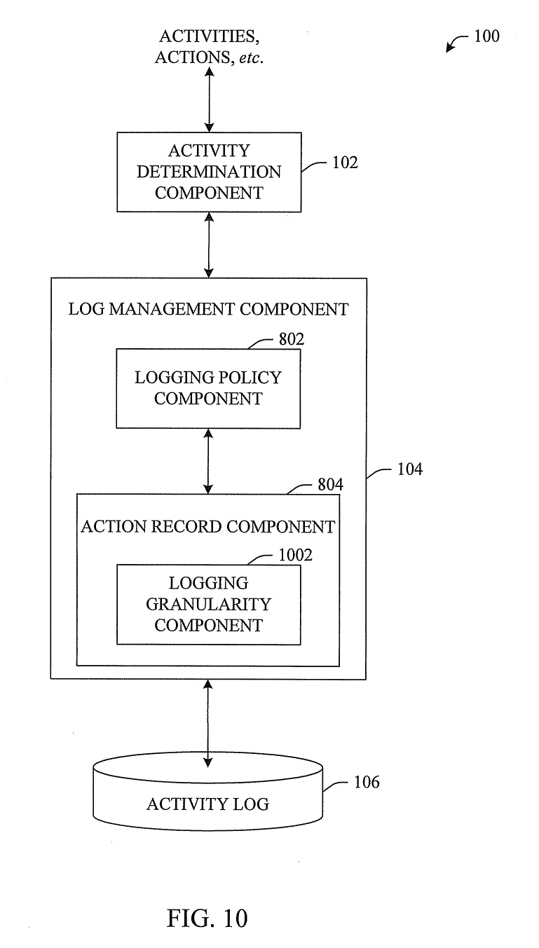

Turning now to FIG. 10, as shown, the action record component 804 can include a logging granularity component 1002. This component (1002) can manage the granularity (e.g., detail) of information actually recorded. For instance, the granularity can be controlled based upon the activity context (e.g., state), user context (e.g., knowledge), environment context (e.g., time), privacy, etc.

Further, the system 100 can use historical (and/or statistical) data to influence the inference or determination of what should be logged. Moreover, extrinsic data (e.g., activity context, user context, environment context, device profile) can be used to influence the granularity of the logging. For example, if a user is working on an activity via a Smartphone or PDA, the system might log less information as memory space and processing power are more limited as would be the case if employing a desktop computer. Thus, the performance tradeoffs can dictate and/or affect what, if any, information is logged.

In another example, the system can learn from a user action. For instance, if the system 100 is logging email interactions and a user explicitly designates an email from a particular sender as junk mail, the system can learn from this action and no longer log email interactions from this particular sender. Additionally, the system 100 can use a granularity component 1002 to determine the level of granularity with respect to individually logged actions. As such, via the granularity component 1002, the system 100 can dynamically adjust the logging frequency based upon any factors including, but, not limited to, performance, resources, implicit or explicit user feedback, learning or classification.

As described above, the logging policy component 802 can include at least three basic layers or sub-components (902, 904, 906). In operation, the policy manager (802) can look to the corporate (or home or community) level, the application level, the system level, the user level, etc. to manage the overall logging processes. For example, a logging action that logs what files have been opened can be performed at any of the three driver levels described above. Once the policy is determined, the granularity component 1002 can determine the level of logging detail with respect to a particular identified policy.

Another feature of the innovation is that the system 100 can automate identification of the activity and can build upon the activity by dynamically analyzing the content of keyboard inputs, sound recognition (e.g., speech), gestures, eye tracking, etc. As described above, the logged information can include events/information from a particular machine or set of machines, which represents electronic documents and activities on those specific machines. As well, the logged information can include events/information in the environment which looks to people in the room, ambient temperature, etc. Still further, the information can include a user state/context, for example, biometrics and other user specific factors such as user's knowledge of a topic, mood, state of mind, location information, etc.

As described in greater detail in the Related Applications identified above, as activities that involve groups are delegated or are shared, the log information can also be shared between users and/or disparate devices. By sharing this log information, disparate logs can be consolidated, combined and/or aggregated to enable an extremely comprehensive activity-centric system. Thus, a particular user's activity log can include information related to the individual as well as the group with respect to a particular activity.

It will be understood that the logging policies (902, 904, 906) can include privacy settings such as, identification of information that is shareable and information that is not shareable. As described above, this determination can be made upon factors including, but not limited to, nature of the activity, role of a user, sensitivity of data, etc. Of course, privacy policies can be applied when the information is monitored, recorded or logged as well as when the decision is made to share or not to share the information. For example, a user might want to record everything for journaling purposes but, might choose not to share all of the information with a complete activity team.

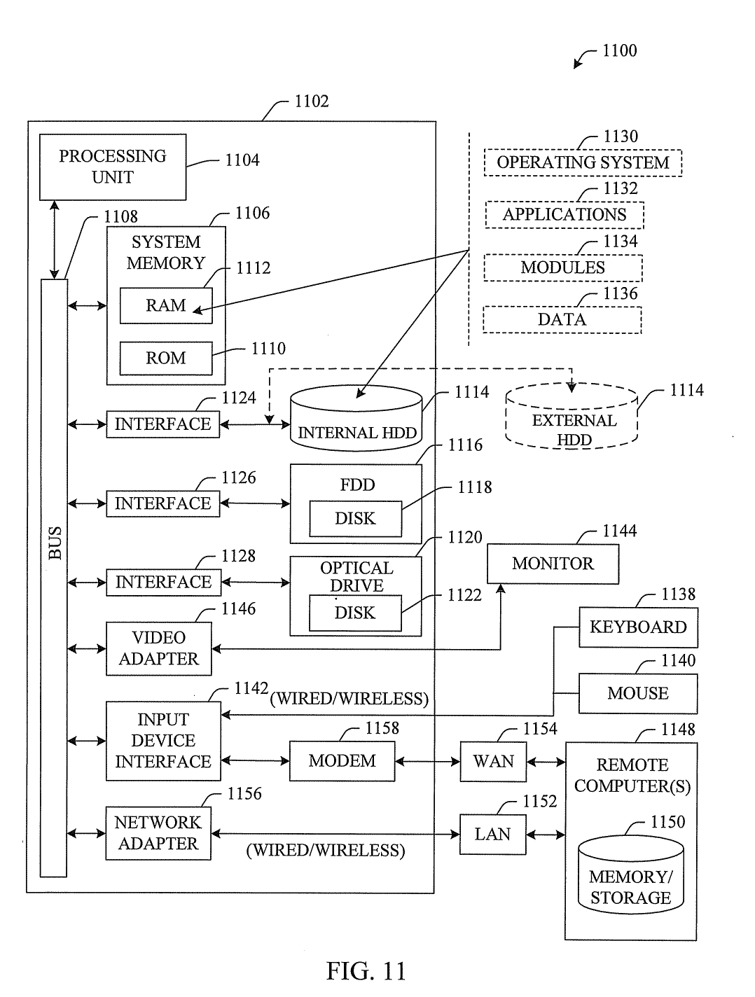

Referring now to FIG. 11, there is illustrated a block diagram of a computer operable to execute the disclosed architecture of logging user actions. In order to provide additional context for various aspects of the subject innovation, FIG. 11 and the following discussion are intended to provide a brief, general description of a suitable computing environment 1100 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the innovation includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

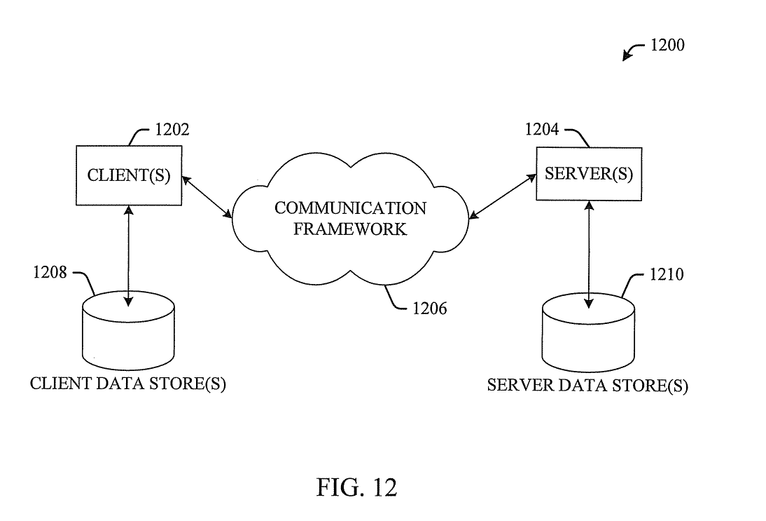

Referring now to FIG. 12, there is illustrated a schematic block diagram of an exemplary computing environment 1200 in accordance with the subject innovation. The system 1200 includes one or more client(s) 1202. The client(s) 1202 can be hardware and/or software (e.g., threads, processes, computing devices). The client(s) 1202 can house cookie(s) and/or associated contextual information by employing the innovation, for example.

The system 1200 also includes one or more server(s) 1204. The server(s) 1204 can also be hardware and/or software (e.g., threads, processes, computing devices). The servers 1204 can house threads to perform transformations by employing the innovation, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates logging actions related to an activity, comprising:
an activity determination component that identifies an activity associated with a plurality of actions; and
a log management component that logs a subset of the plurality of actions based at least in part upon the activity.

2. The system of claim 1, the activity determination component employs a monitoring component that dynamically tracks the plurality of actions.

3. The system of claim 2, the plurality of actions comprise user interactions that include at least one of key strokes, speech, gestures, eye movements, communication events and data accessed.

4. The system of claim 2, the activity determination component employs an extrinsic data collaboration component that receives extrinsic data, the activity determination component employs a subset of the extrinsic data to identify the activity.

5. The system of claim 4, the extrinsic data includes at least one of personal information manager (PIM) data, environment context data, user context information, device profile/context information, activity context information and user state.

6. The system of claim 4, the log management component logs at least a subset of the extrinsic data associated to the activity.

7. The system of claim 2, further comprising an activity inference component that infers the activity based at least in part upon a subset of the plurality of actions.

8. The system of claim 7, the activity inference component infers the activity from a subset of extrinsic data.

9. The system of claim 2, the activity determination component includes an extrinsic data collaboration component that determines the activity based at least in part upon extrinsic data related to the subset of the plurality of actions.

10. The system of claim 1, further comprising:
a logging policy component that employs a policy to determine the subset of the plurality of actions to log; and
an action record component that logs the plurality of actions in an activity log.

11. The system of claim 10, the policy is a generic policy component that enables a user to identify the subset of the plurality of actions to log.

12. The system of claim 10, the policy is a third party policy that enables a third party to dictate the subset of the plurality of actions to log.

13. The system of claim 10, the policy is a first party policy that enables a developer of an application to determine the subset of the plurality of actions to log with respect to the application.

14. The system of claim 10, the action record component includes a granularity component that adjusts a recording threshold related to the plurality of actions.

15. The system of claim 1, further comprising a machine learning and reasoning component that automatically infers the activity based at least in part upon the subset of the plurality of actions.

16. A method of logging user actions associated with an activity, comprising:
monitoring a plurality of user actions;
determining an activity associated with a subset of the plurality of user actions; and
logging a subset of the plurality of user actions.

17. The method of claim 16, further comprising logging extrinsic data associated to the subset of the plurality of user actions.

18. The method of claim 17, further comprising consolidating the logged subset of the plurality of user actions with a plurality of activity actions associated with a disparate user.

19. A system that facilitates logging user actions associated with an activity, comprising:
means for observing actions of a user;
means for determining a subset of the actions of the user based at least in part upon a policy;
means for associating the subset of the actions of the user to the activity;
means for tagging the subset of the actions of the user to the activity; and
means for logging the subset of the actions of the user.

20. The system of claim 19, further comprising:
means for gathering extrinsic data related to the subset of the actions of the user; and
means for logging the extrinsic data.
